(19) United States
(12) Patent Application Publication
(10) Pub. No.: US 2008/0250323 A1
(43) Pub. Date: Oct. 9, 2008

(54) Method and apparatus for recommending an application-feature to a user

(76) Inventor: Gerald B. Huff, Berkeley, CA (US)

Correspondence Address: PVF -- INTUIT, INC.;c/o PARK, VAUGHAN & FLEMING LLP, 2820 FIFTH STREET, DAVIS, CA, 95618-7759, US

(21) Appl. No.: 11/732,850

(22) Filed: Apr. 4, 2007

(51) Int. Cl. G06F 3/00

(52) U.S. Cl. 715/733

(57) ABSTRACT

One embodiment of the present invention provides a system for recommending an application-feature to a user. During operation, the system receives application-usage information from a client at a recommendation-server, wherein the application-usage information specifies characteristics of a user's interaction with an application. Next, the system compares the application-usage information to additional application-usage information from other users to identify a usage-group, which contains users who use the application similarly to the user. The system then identifies an application-feature associated with the usage-group, but which is not associated with the user. Finally, the system sends to the client an application-feature identifier, which identifies the application-feature, to facilitate recommending the application-feature to the user.

### BACKGROUND

### Related Art

The complexity of software is steadily increasing as software developers create applications that include an increasing number of features. Determining which application-features to use to complete a given task can be challenging. Moreover, a number of applications provide multiple features that can be used to complete a given task, which makes selecting an application-feature even more challenging, particularly for novice users. As a result, many users operate within a small “comfort zone” within an application and thus, tend to use only a small percentage of available application-features.

Organizations often release new versions of popular applications, which include many new application-features. Typically, a user only desires to purchase a new version of an application if the new version provides application-features which significantly improve the user's productivity. However, it is often difficult for the user to determine a priori if the new version of the application will benefit the user. Thus, the user may waste time trying the new version of the application.

### SUMMARY

One embodiment of the present invention provides a system for recommending an application-feature to a user. During operation, the system receives application-usage information from a client at a recommendation-server, wherein the application-usage information specifies characteristics of a user's interaction with an application. Next, the system compares the application-usage information to additional application-usage information from other users to identify a usage-group, which contains users who use the application similarly to the user. The system then identifies an application-feature associated with the usage-group, but which is not associated with the user. Finally, the system sends to the client an application-feature identifier, which identifies the application-feature, to facilitate recommending the application-feature to the user.

In another embodiment, the application is a web-based application. In this embodiment, receiving the application-usage information involves receiving the application-usage information from a web-server.

In another embodiment, users who use the application similarly use at least a predetermined number of application-features from a given subset of application-features.

In yet another embodiment, the system receives updated application-usage information from users associated with the usage-group. Then, the system determines from the updated application-usage information if the users associated with the usage-group are continuing to use a given application-feature. If not, the system disassociates the given application-feature from the usage-group, which involves removing the given application-feature from the given subset of application-features.

In another embodiment, comparing the application-usage information to the additional application-usage information can involve comparing: application-features used; techniques used for accessing the application-features; frequency of accesses to the application-features; application-data accessed by the application (including application-data created by the user and application-data stored by the application); metadata associated with the accessed application-data; and demographic-data associated with the user and the other users.

In another embodiment, recommending the application-feature can involve: highlighting the application-feature; enlarging an icon associated with the application-feature; shrinking icons not associated with the application-feature to emphasize the icon associated with the application-feature; hiding icons not associated with the application-feature to emphasize the icon associated with the application-feature; presenting a system-message to the user; specifying the application-feature in a user-accessible list of recommended application-features; sending the user an e-mail; and presenting a dialog-box to the user.

In another embodiment, the application-feature can be included as part of: the application; an add-on; a plug-in; a free upgrade; a purchasable upgrade; and a third-party application.

In another embodiment, the system sends to the client an updated toolbar associated with the usage-group to enable the application to format a toolbar associated with the application to match the user's application-usage pattern.

In another embodiment, the system recommends to the user application-data associated with the usage-group.

### BRIEF DESCRIPTION OF THE FIGURES

FIG. 1 illustrates a computing environment in accordance with an embodiment of the present invention.

FIG. 2 presents a flow chart illustrating a process for recommending an application-feature to a user in accordance with an embodiment of the present invention.

FIG. 3 presents a flow chart illustrating a process for disassociating an application-feature from a usage-group in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

One embodiment of the present invention provides a recommendation-server that recommends application-features to a user. The recommendation-server accomplishes this by comparing application-usage information received from the user to application-usage information received from other users to identify a usage-group. This usage-group identifies a set of users who use the application similarly to the user. The recommendation-server can then identify an application-feature that users associated with the usage-group use, but that the user does not use. After identifying the application-feature, the recommendation-server recommends the application-feature to the user.

In one embodiment of the present invention, the recommendation-server can identify: an upgrade of an application; a new version of the application; and a third-party application associated with the usage-group that the user does not use. Note that the upgrade of the application, the new version of the application, and the third-party application may be free or may have a fee associated with them. In this embodiment, the recommendation-server can then recommend the upgrade of the application, the new version of the application, and the third-party application to the user.

In one embodiment of the present invention, the recommendation-server can recommend to the user application-data associated with the usage-group. For example, if users associated with the usage-group typically use value X in a particular data-field associated with the application, then the recommendation-server can recommend the user use value X for the particular data-field.

In one embodiment of the present invention, the recommendation process is self-correcting. In this embodiment, during a given time-period, if a predetermined number of users associated with the usage-group do not use an application-feature associated with the usage-group, the recommendation-server can disassociate the application-feature from the usage-group. Similarly, during a given time-period, if a predetermined number of users associated with the usage-group use an application-feature that is not associated with the usage-group, the recommendation-server can associate the application-feature with the usage-group. The recommendation-server can then recommend the application-feature to the users associated with the usage-group who do not use the application-feature.

In one embodiment of the present invention, during a given time-period, if a user who is not associated with the usage-group uses a predetermined-number of application-features, the recommendation-server can associate the user with the usage-group. Similarly, during a given time-period, if a user who is associated with the usage-group does not use a predetermined number of application-features, the recommendation-server can disassociate the user from the usage-group. Note that the recommendation-server may then associate the user with a different usage-group associated with users who use the application similarly to how the user presently uses the application.

### Computing Environment

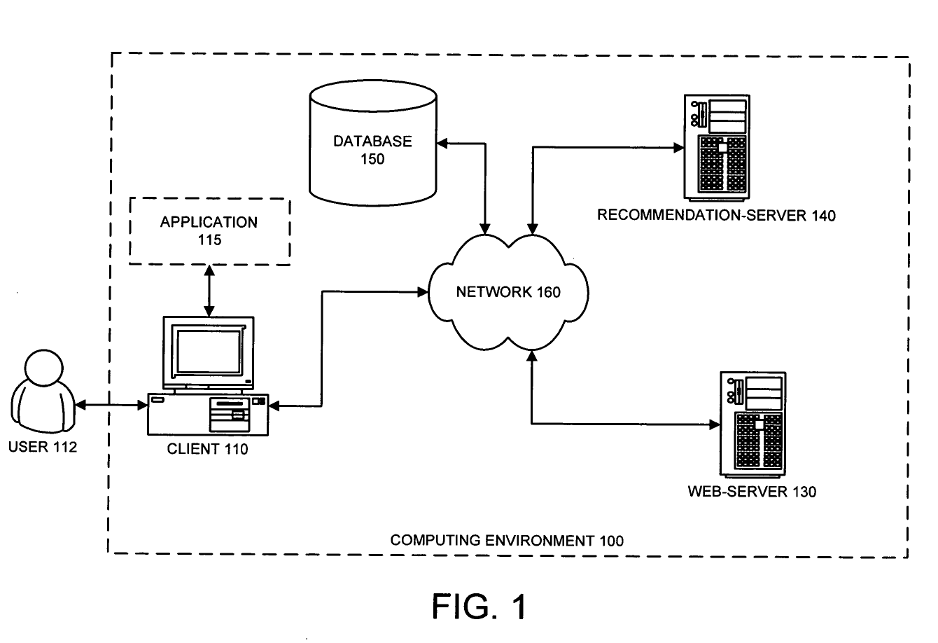

FIG. 1 illustrates a computing environment 100 in accordance with an embodiment of the present invention. Computing environment 100 includes a number of computer systems, which can generally include any type of computer system based on: a microprocessor, a mainframe computer, a digital signal processor, a portable computing device, a personal organizer, a device controller, or a computational engine within an appliance. More specifically, computing environment 100 includes client 110, application 115, web-server 130, recommendation-server 140, database 150, and network 160.

Client 110 can generally include any node on a network including computational capability and including a mechanism for communicating across the network.

Application 115 can generally include any application that a client or server can host. In one embodiment of the present invention, client 110 hosts application 115.

In one embodiment of the present invention, application 115 can be a web-based application. In this embodiment, a web-server, such as web-server 130, hosts application 115.

Web-server 130, and recommendation-server 140 can generally include any computational node including a mechanism for servicing requests from a client for computational and/or data storage resources.

Recommendation-server 140 can generally include any system that can analyze application-usage information, and can recommend to a user an application-feature based on the results of the analysis.

Database 150 can generally include any type of system for storing data in non-volatile storage. This includes, but is not limited to, systems based upon: magnetic, optical, and magneto-optical storage devices, as well as storage devices based on flash memory and/or battery-backed up memory. In one embodiment of the present invention, database 150 can store application-usage information.

Network 160 can generally include any type of wired or wireless communication channel capable of coupling together computing nodes. This includes, but is not limited to, a local area network, a wide area network, or a combination of networks. In one embodiment of the present invention, network 160 comprises the Internet.

User 112 can generally include: an individual; a group of individuals; an organization; a group of organizations; a computing system; a group of computing systems; or any other entity that can interact with computing environment 100.

In one embodiment of the present invention, user 112 can be a client.

### Recommending an Application-Feature

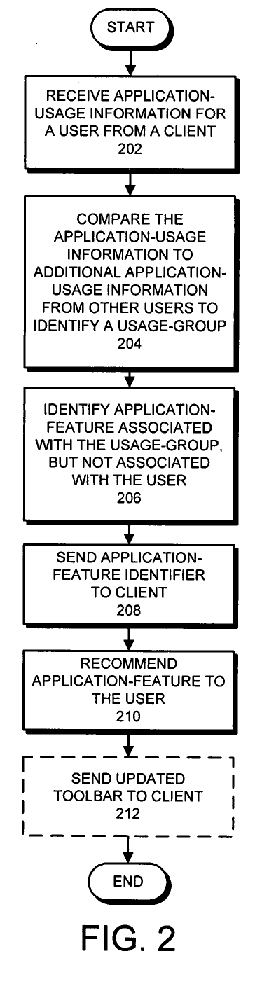

FIG. 2 presents a flow chart illustrating a process for recommending an application-feature to a user 112 in accordance with an embodiment of the present invention. The process begins when recommendation-server 140 receives, from client 110, application-usage information associated with application 115 and user 112 (operation 202). Note that this application-usage information can include: a list of application-features that user 112 used; the techniques user 112 used for accessing these application-features, such as whether user 112 used a hot-key, or clicked on a toolbar icon; the frequency with which user 112 accessed these application-features; application-data accessed by user 112; metadata associated with the accessed application-data; demographic-data associated with user 112; and any other information that describes user 112's interaction with application 115.

In one embodiment of the present invention, recommendation-server 140 can request additional information from user 112 to facilitate recommending the application-feature. In this embodiment, user 112 may or may not send the additional information to recommendation-server 140.

In one embodiment of the present invention, recommendation-server 140 may analyze the application-usage information to obtain additional information to facilitate recommending the application-feature. Note that this involves extrapolating new data from existing data by analyzing relationships between the existing data.

In one embodiment of the present invention, application 115 is a web-based application that web-server 130 hosts. In this embodiment, recommendation-server 140 receives the application-usage information from web-server 130, which records user 112's interaction with application 115.

Next, recommendation-server 140 compares the application-usage information to additional application-usage information associated with other users to identify a usage-group (operation 204). Comparing the application-usage information to the additional application-usage information can involve comparing: application-features used; techniques for accessing the application-features; the frequency of accesses to the application-features; the application-data accessed by the application; metadata associated with the accessed application-data; demographic-data associated with user 112 and the other users; and any other information related to user 112's use or the other users' use of application 115. Note that the usage-group contains users who use application 115 similarly to each other. Furthermore, note that users who use application 115 similarly to each other, use at least a predetermined number of application-features from a given subset of application-features.

In one embodiment of the present invention, recommendation-server 140 retrieves the additional application-usage information from database 150.

In one embodiment of the present invention, recommendation-server 140 saves the application-usage information on database 150.

In one embodiment of the present invention, users who use application 115 similarly use at least a predetermined ratio of application-features from a given subset of application-features.

In one embodiment of the present invention, application-features are associated with a weighted value. In this embodiment, users who use application 115 similarly use at least a weighted predetermined ratio of application-features from a given subset of application-features. This weighted predetermined ratio is a ratio of the summation of numerical weights associated with a subset of the given subset of application-features to a summation of numerical weights associated with the entire given subset of application-features.

In one embodiment of the present invention, the predetermined number, the predetermined ratio, or the weighted predetermined ratio can be selected by: a developer of recommendation-server 140; an organization using recommendation-server 140; an administrator of recommendation-server 140; user 112; or an automatic mechanism.

In one embodiment of the present invention, recommendation-server 140 determines which users belong to a usage-group based on the predetermined number, predetermined ratio, or weighted predetermined ratio associated with the users.

In one embodiment of the present invention, recommendation-server 140 updates a given usage-group to associate a new user with the usage-group, or to disassociate an existing user from the usage group. This can occur: continuously; at a user-specified time; at a periodic time; in response to receiving application-usage information from user 112; in response to a new user accessing application 115 or recommendation-server 140; and at any other time that user 112, an organization, or a system-developer configures recommendation-server 140 to update a given usage-group or set of usage-groups.

In one embodiment of the present invention, user 112 can belong to multiple usage-groups.

Recommendation-server 140 then identifies an application-feature associated with the usage-group (operation 206), but which is not associated with user 112 (as is indicated by the application-usage information). Next, recommendation-server 140 sends an application-feature identifier, which identifies the application-feature, to client 110 (operation 208). This application-feature identifier allows recommendation-server 140, application 115, or an organization associated with application 115 to recommend the application-feature to user 112 (operation 210). Note that the application-feature can be: an application-feature that is an existing part of application 115; an add-on to application 115; a plug-in for application 115; a free upgrade to application 115; a purchasable upgrade to application 115; a third-party application or an application-feature associated with a third-party application; a free update to application 115; a purchasable update to application 115; and any other application-feature that user 112 can use with application 115.

In one embodiment of the present invention, recommending the application-feature can involve: highlighting the application-feature by highlighting an icon, a shortcut, or a menu item associated with the application-feature; enlarging an icon or a menu item associated with the application-feature; shrinking icons or menu items not associated with the application-feature to emphasize an icon or a menu item that is associated with the application-feature; hiding icons or menu items not associated with the application-feature to emphasize an icon or a menu item that is associated with the application-feature; presenting a system-message to user 112; specifying the application-feature in a user-accessible list of recommended application-features; sending user 112 an e-mail that specifies the application-feature; presenting a dialog-box to user 112 that specifies the application-feature; and any other method for recommending an application-feature to user 112. Note that the method of recommending the application-feature to user 112 can be obtrusive, unobtrusive, passive, or active. Furthermore, note that user 112 can configure application 115 to select a method for receiving application-feature recommendations.

In one embodiment of the present invention, recommending an application-feature can involve specifying: how to access the application-feature; how to use the application-feature; and why the application-feature was recommended to user 112.

In one embodiment of the present invention, recommendation-server 140 can send client 110 an updated toolbar (operation 212) to amend an existing toolbar that is associated with application 115. This updated toolbar is associated with the usage-group that recommendation-server 140 identified based on user 112's application usage-information. Note that recommendation-server 140 determines the configuration of this updated toolbar based on the additional application-usage information associated with the other users to optimize user 112's user-experience and productivity by making it easier for user 112 to access application-features associated with the usage-group. In this embodiment, recommendation-server 140 can format the toolbar to match user 112's application-usage pattern. Furthermore, note that user 112 can decline to amend the existing toolbar with the updated toolbar. Moreover, note that operation 212 is optional as is illustrated by the dashed lines surrounding operation 212.

In one embodiment of the present invention, recommendation-server 140 can send client 110 an updated menu layout to amend an existing menu layout that is associated with application 115. This updated menu layout is associated with the usage-group that recommendation-server 140 identified based on user 112's application usage-information. Note that recommendation-server 140 determines the configuration of this updated menu layout based on the additional application-usage information associated with the other users to optimize user 112's user-experience and productivity by making it easier for user 112 to access application-features associated with the usage-group. In this embodiment, recommendation-server 140 can format the menu layout to match user 112's application-usage pattern. Furthermore, note that user 112 can decline to amend the existing menu layout with the updated menu layout.

### Adjusting to Changes in Application-Usage and in Usage-Groups Over Time

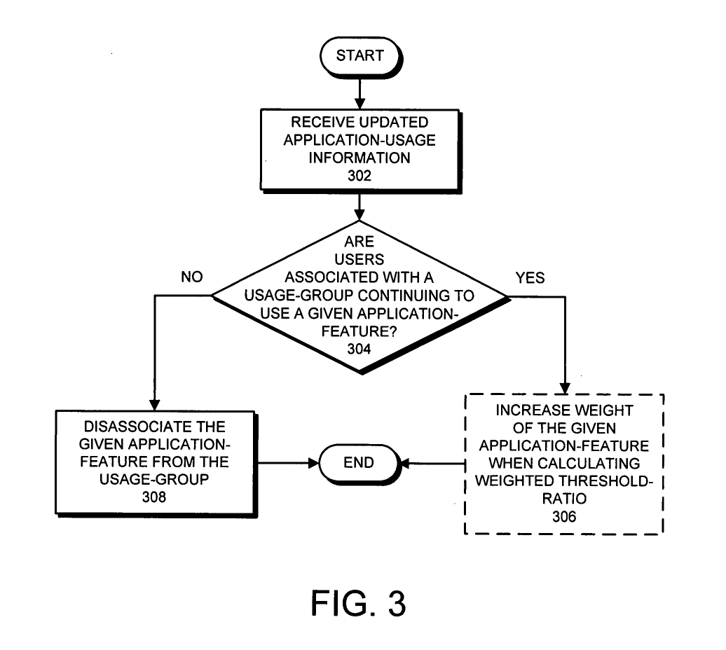

FIG. 3 presents a flow chart illustrating a process for disassociating an application-feature from a usage-group in accordance with an embodiment of the present invention. The process begins when recommendation-server 140 receives updated application-usage information (operation 302) from users associated with a usage-group. Recommendation-server 140 then determines from the updated application-usage information if the users associated with the usage-group are continuing to use a given application-feature (operation 304). If not, recommendation-server 140 disassociates the given application-feature from the usage-group (operation 308). Note that this may involve removing the given application-feature from a given subset of application-features that recommendation-server 140 uses to determine if users are using application 115 similarly. Furthermore, determining if the users associated with the usage-group are continuing to use the given application-feature can involve determining if a threshold-percentage of the users is continuing to use the given application-feature.

In one embodiment of the present invention, determining if the users associated with the usage-group are continuing to use the given application-feature can involve determining if the users associated with the usage-group are continuing to use the given application-feature during a given time-period. Note that this time-period can be specified by: user 112; a developer of recommendation-server 140; an administrator of recommendation-server 140; or an organization using recommendation-server 140.

In one embodiment of the present invention, suppose that, during a given time-period, the users associated with the usage-group are continuing to use the given application-feature, then recommendation-server 140 may increase the weight of the given application-feature when calculating a weighted predetermined ratio (operation 306). Note that operation 306 is optional as is illustrated by the dashed lines surrounding operation 306.

In one embodiment of the present invention, suppose that, during a given time-period, recommendation-server 140 determines that a threshold-percentage of users who are associated with the usage-group are using an application-feature not associated with the usage-group. In this case, recommendation-server 140 can associate the application-feature with the usage-group. Note that this may involve adjusting the predetermined number, the predetermined ratio, or the weighted predetermined ratio used to determine if user 112 should be associated with the usage-group. Recommendation-server 140 can then recommend the application-feature to users associated with the usage-group who are not using the application-feature.

In one embodiment of the present invention, suppose that, during a given time-period, recommendation-server 140 determines that a user who is associated with a usage-group is no longer using application 115 similarly to the usage-group. In this case, recommendation-server 140 can disassociate the user from the usage-group. Recommendation-server 140 can then un-recommend the application-feature to users associated with the usage-group who are not using the application-feature. Note that this may involve: removing a highlight from an icon, a shortcut, or a menu item associated with the application-feature; shrinking an icon or a menu item associated with the application-feature to match the size of other icons or menu items associated with application 115; enlarging icons or menu items not associated with the application-feature to match the size of the application-feature; revealing icons or menu items not associated with the application-feature to de-emphasize an icon or a menu item that is associated with the application-feature; removing specification of the application-feature in a user-accessible list of recommended application-features; and any other method for un-recommending to de-emphasizing an application-feature to user 112.

In one embodiment of the present invention, if recommendation-server 140 determines that the number of users associated with a usage-group has decreased below a predetermined number of users, recommendation-server 140 can disband the usage-group.

In one embodiment of the present invention, suppose that recommendation-server 140 determines that a user who is not associated with a usage-group has begun using application 115 similarly to the usage-group for a given time-period. In this case, recommendation-server 140 can associate the user with the usage-group. Note that the user can be associated with multiple usage-groups.

In one embodiment of the present invention, if recommendation-server 140 determines that the number of users associated with a usage-group has increased above a predetermined number of users, recommendation-server 140 can adjust: a predetermined number, a predetermined ratio, or a weighted predetermined ratio used to determine if users should be associated with the usage-group. This enables recommendation-server 140 to adjust the level of similarity required between user 112 and a usage-group before recommendation-server 140 will associate user 112 with the usage-group.

In one embodiment of the present invention, if recommendation-server 140 determines that a predetermined number of users are using application 115 similarly over a given time-period, and that a usage-group does not exist to associate these users with each other, then recommendation-server 140 can create a new usage-group to associate these users together. Note that when an organization first installs recommendation-server 140, recommendation-server 140 uses this embodiment to create the initial usage-groups.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for recommending an application-feature to a user, the method comprising:
receiving application-usage information from a client at a recommendation-server, wherein the application-usage information specifies characteristics of a user's interaction with an application;
comparing the application-usage information to additional application-usage information from other users to identify a usage-group, which contains users who use the application similarly to the user;
identifying an application-feature associated with the usage-group, but that is not associated with the user; and
sending to the client an application-feature identifier, which identifies the application-feature, to facilitate recommending the application-feature to the user.

2. The method of claim 1,
wherein the application is a web-based application; and
wherein receiving the application-usage information involves receiving the application-usage information from a web-server.

3. The method of claim 1, wherein users who use the application similarly use at least a predetermined number of application-features from a given subset of application-features.

4. The method of claim 3, further comprising:
receiving updated application-usage information from users associated with the usage-group;
determining from the updated application-usage information if the users associated with the usage-group are continuing to use a given application-feature; and
if not, disassociating the given application-feature from the usage-group, which involves removing the given application-feature from the given subset of application-features.

5. The method of claim 1, wherein comparing the application-usage information to the additional application-usage information can involve comparing:
application-features used;
techniques used for accessing the application-features;
frequency of accesses to the application-features;
application-data accessed by the application;
metadata associated with the accessed application-data; and
demographic-data associated with the user and the other users.

6. The method of claim 1, wherein recommending the application-feature can involve:
highlighting the application-feature;
enlarging an icon associated with the application-feature;
shrinking icons not associated with the application-feature to emphasize the icon associated with the application-feature;
hiding icons not associated with the application-feature to emphasize the icon associated with the application-feature;
presenting a system-message to the user;
specifying the application-feature in a user-accessible list of recommended application-features;
sending the user an e-mail; and
presenting a dialog-box to the user.

7. The method of claim 1, wherein the application-feature can be included as part of:
the application;
an add-on;
a plug-in;
a free upgrade;
a purchasable upgrade; and
a third-party application.

8. The method of claim 1, further comprising sending to the client an updated toolbar associated with the usage-group to enable the application to format a toolbar associated with the application to match the user's application-usage pattern.

9. The method of claim 1, wherein recommending the application-feature can involve recommending application-data associated with the usage-group.

10. A computer-readable storage medium storing instructions that when executed by a computer cause the computer to perform a method for recommending an application-feature to a user, the method comprising:
receiving application-usage information from a client at a recommendation-server, wherein the application-usage information specifies characteristics of a user's interaction with an application;
comparing the application-usage information to additional application-usage information from other users to identify a usage-group, which contains users who use the application similarly to the user;
identifying an application-feature associated with the usage-group, but that is not associated with the user; and
sending to the client an application-feature identifier, which identifies the application-feature, to facilitate recommending the application-feature to the user.

11. The computer-readable storage medium of claim 10,
wherein the application is a web-based application; and
wherein receiving the application-usage information involves receiving the application-usage information from a web-server.

12. The computer-readable storage medium of claim 10, wherein users who use the application similarly use at least a predetermined number of application-features from a given subset of application-features.

13. The computer-readable storage medium of claim 12, wherein the method further comprises:
receiving updated application-usage information from users associated with the usage-group;
determining from the updated application-usage information if the users associated with the usage-group are continuing to use a given application-feature; and
if not, disassociating the given application-feature from the usage-group, which involves removing the given application-feature from the given subset of application-features.

14. The computer-readable storage medium of claim 10, wherein comparing the application-usage information to the additional application-usage information can involve comparing:
application-features used;
techniques used for accessing the application-features;
frequency of accesses to the application-features;
application-data accessed by the application;
metadata associated with the accessed application-data; and
demographic-data associated with the user and the other users.

15. The computer-readable storage medium of claim 10, wherein recommending the application-feature can involve:
highlighting the application-feature;
enlarging an icon associated with the application-feature;
shrinking icons not associated with the application-feature to emphasize the icon associated with the application-feature;
hiding icons not associated with the application-feature to emphasize the icon associated with the application-feature;
presenting a system-message to the user;
specifying the application-feature in a user-accessible list of recommended application-features;
sending the user an e-mail; and
presenting a dialog-box to the user.

16. The computer-readable storage medium of claim 10, wherein the application-feature can be included as part of:
the application;
an add-on;
a plug-in;
a free upgrade;
a purchasable upgrade; and
a third-party application.

17. The computer-readable storage medium of claim 10, wherein the method further comprises sending to the client an updated toolbar associated with the usage-group to enable the application to format a toolbar associated with the application to match the user's application-usage pattern.

18. The computer-readable storage medium of claim 10, wherein recommending the application-feature can involve recommending application-data associated with the usage-group.

19. An apparatus that recommends an application-feature to a user, comprising:
a receiving mechanism configured to receive application-usage information from a client at a recommendation-server, wherein the application-usage information specifies characteristics of a user's interaction with an application;
a comparison mechanism configured to compare the application-usage information to additional application-usage information from other users to identify a usage-group, which contains users who use the application similarly to the user;
an identification mechanism configured to identify an application-feature associated with the usage-group, but that is not associated with the user; and
a sending mechanism configured to send to the client an application-feature identifier, which identifies the application-feature, to facilitate recommending the application-feature to the user.

20. The apparatus of claim 19,
wherein the application is a web-based application; and
wherein the receiving mechanism is further configured to receive the application-usage from a web-server.

21. The apparatus of claim 19, wherein the receiving mechanism is further configured to receive updated application-usage information from users associated with the usage-group, and further comprising:
a determination mechanism configured to determine from the updated application-usage information if the users associated with the usage-group are continuing to use a given application-feature; and
a disassociation mechanism configured to disassociate the given application-feature from the usage-group, which involves removing the given application-feature from a given subset of application-features.

22. The apparatus of claim 19, wherein the comparison mechanism is further configured to compare:
application-features used;
techniques used for accessing the application-features;
frequency of accesses to the application-features;
application-data accessed by the application;
metadata associated with the accessed application-data; and
demographic-data associated with the user and the other users.

23. The apparatus of claim 19, further comprising a recommendation mechanism configured to recommend the application-feature by:
highlighting the application-feature;
enlarging an icon associated with the application-feature;
shrinking icons not associated with the application-feature to emphasize the icon associated with the application-feature;
hiding icons not associated with the application-feature to emphasize the icon associated with the application-feature;
presenting a system-message to the user;
specifying the application-feature in a user-accessible list of recommended application-features;
sending the user an e-mail; and
presenting a dialog-box to the user.

24. The apparatus of claim 19, wherein the sending mechanism is further configured to send to the client an updated toolbar associated with the usage-group to enable the application to format a toolbar associated with the application to match the user's application-usage pattern.

25. A method for recommending an application-feature to a user, the method comprising:
sending application-usage information from a client to a recommendation-server, wherein the application-usage information specifies characteristics of a user's interaction with an application and facilitates in identifying a usage-group and identifying an application-feature associated with the usage-group;
receiving at the client an application-feature identifier; and
recommending the application-feature identified by the application-feature identifier to the user.

26. The method of claim 25:
wherein the application is a web-based application; and
wherein receiving the application-usage information involves receiving the application-usage information from a web-server.

27. The method of claim 25, wherein users who use the application similarly use at least a predetermined number of application-features from a given subset of application-features.

28. The method of claim 25, wherein recommending the application-feature can involve:
highlighting the application-feature;
enlarging an icon associated with the application-feature;
shrinking icons not associated with the application-feature to emphasize the icon associated with the application-feature;
hiding icons not associated with the application-feature to emphasize the icon associated with the application-feature;
presenting a system-message to the user;
specifying the application-feature in a user-accessible list of recommended application-features;
sending the user an e-mail; and
presenting a dialog-box to the user.

29. The method of claim 25, wherein the application-feature can be included as part of:
the application;
an add-on;
a plug-in;
a free upgrade;
a purchasable upgrade; and
a third-party application.

30. The method of claim 25, further comprising:
receiving at the client an updated toolbar format associated with the usage-group; and
formatting a toolbar associated with the application to match the updated toolbar format.

31. The method of claim 25, wherein recommending the application-feature can involve recommending application-data associated with the usage-group.

32. A computer-readable storage medium storing instructions that when executed by a computer cause the computer to perform a method for recommending an application-feature to a user, the method comprising:
sending application-usage information from a client to a recommendation-server, wherein the application-usage information specifies characteristics of a user's interaction with an application and facilitates in identifying a usage-group and identifying an application-feature associated with the usage-group;
receiving at the client an application-feature identifier; and
recommending the application-feature identified by the application-feature identifier to the user.

33. The computer-readable storage medium of claim 32:
wherein the application is a web-based application; and
wherein receiving the application-usage information involves receiving the application-usage information from a web-server.

34. The computer-readable storage medium of claim 32, wherein users who use the application similarly use at least a predetermined number of application-features from a given subset of application-features.

35. The computer-readable storage medium of claim 32, wherein recommending the application-feature can involve:
highlighting the application-feature;
enlarging an icon associated with the application-feature;
shrinking icons not associated with the application-feature to emphasize the icon associated with the application-feature;
hiding icons not associated with the application-feature to emphasize the icon associated with the application-feature;
presenting a system-message to the user;
specifying the application-feature in a user-accessible list of recommended application-features;
sending the user an e-mail; and
presenting a dialog-box to the user.

36. The computer-readable storage medium of claim 32, wherein the application-feature can be included as part of:
the application;
an add-on;
a plug-in;
a free upgrade;
a purchasable upgrade; and
a third-party application.

37. The computer-readable storage medium of claim 32, wherein the method further comprises:
receiving at the client an updated toolbar format associated with the usage-group; and
formatting a toolbar associated with the application to match the updated toolbar format.

38. The computer-readable storage medium of claim 32, wherein recommending the application-feature can involve recommending application-data associated with the usage-group.
